(19) United States
(12) Patent Application Publication
(10) Pub. No.: US 2014/0047872 A1
(43) Pub. Date: Feb. 20, 2014

(54) Dual-Key Lock

(71) Applicant: Chun Te YU, Changhua County (TW)

(72) Inventor: Chun Te YU, Changhua County (TW)

(21) Appl. No.: 13/969,159

(22) Filed: Aug. 16, 2013

(30) Foreign Application Priority Data
Aug. 17, 2012 (TW) 101129966

(51) Int. Cl. E05B 39/00; E05B 67/08

(52) U.S. Cl. CPC E05B 39/00; E05B 67/08
USPC 70/41; 70/31

(57) ABSTRACT

A dual-key lock includes a lock body and a dual-key lock mechanism. The dual-key lock mechanism includes a spindle for receiving a first key and a second key which can unlock the dual-key lock mechanism. While the spindle is operated by the first key, the spindle is configured to move from an original position to an indicative position and stay in the indicative position. And, while the spindle is operated by the, second key, the spindle is further configured to return from the indicative position into the original position.

### BACKGROUND OF INVENTION

1. Field of Invention

The present invention relates to a dual-key lock and, more particularly, to a dual-key lock including an indicator formed with a spindle for receiving two keys so that the indicator is movable into an indicating position from an original position by the first key and returnable into the original position from the indicating position by the second key.

2. Related Prior Art

A conventional lock equipped with an indicator is used to lock a suitcase, a trunk or the like for easy inspection by an inspector of the customs. The inspector can use a specific key to unlock the lock to scrutiny luggage in the suitcase for example without having to break the lock. A user can observe the indicator to determine whether the lock has been unlocked.

Taiwanese Patent Application Publication 200925373 discloses a padlock with an indicating core. The padlock includes a shell, a latch hook and a recovering element in addition to the indicating core. The shell is used to contain the indicating core and the recovering element. The recovering element is connected to the indicating core. The indicating core is operable to lock or unlock. The indicating core is a key-operable core that is movable by a corresponding key into an indicating position from an original position. In the indicating position, a portion of the indicating core is exposed to the exterior of the shell. The indicating core is returnable into the original position from the indicating position by a tool.

U.S. Pat. No. 7,467,531 discloses a dual-key lock with an indicator. The dual-key lock includes a shell, a latch hook and a key-operable core in addition to the indicator. The shell is used to contain the key-operable core. The key-operable core is operable by a master key and a user's key to lock or unlock the latch hook. The indicator is connected to the key-operable core via a controller. The indicator is moved from a first position in the shell into a second position exposed to the exterior of the shell as the key-operable core is operated by the master key. Moreover, the indicator can be returned into the first position from the second position by a recovering device.

### SUMMARY OF INVENTION

It is the primary objective of the present invention to provide a dual-key lock capable of indicating change of status.

A dual-key lock includes a shell and a dual-key locking module. The shell includes an aperture. The dual-key locking module includes a spindle, two locking plates and two springs. The spindle is movable in the shell between an original position and an indicating position, accessible through the aperture, and made with a passageway adaptable for receiving two keys and a recess. The first locking plate is placed in a pocket made in the spindle. The second locking plate placed in another pocket made in the spindle and the recess. The springs bias the first and second locking plates from the spindle. The first key is operable to push the second locking plate out of the recess to move the spindle into the indicating position from the original position while the first locking plate is pushed into the recess by the corresponding spring. The second key is operable to push the first locking plate out of the recess to return the spindle into the original position from the indicating position while the second locking plate is pushed into the recess by the corresponding spring.

In an aspect, the spindle includes an end placed out of the shell as the spindle is in the indicating position.

In another aspect, the dual-key lock further includes a latch hook connected to the shell. The latch hook is adaptable for free movement relative to the shell when one of the keys is operated to turn the dual-key locking module into an unlocking position. The dual-key lock further includes a restraining unit placed in the shell. The restraining unit includes a tongue and a latch-biasing spring for biasing the tongue into a notch made in the latch hook. The tongue is movable with the spindle to release the latch hook and compress the spring as one of the keys is operated to turn the spindle into the unlocking position. The tongue is adaptable for insertion into the notch of the latch hook again by the latch-biasing spring.

In comparison with the prior art, the dual-key lock can advantageously be turned into an unlocking position from a locking position by the first or second key, and the spindle stays in the indicating position after the first key is operated to move the spindle into the indicating position from the original position, and the second key is operable to return the spindle into the original position from the indicating position.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a dual-key lock according to the preferred embodiment of the present invention;

FIG. 2 is a perspective view of two keys and the dual-key lock shown in FIG. 1;

FIG. 3 is another perspective view of the first key shown in FIG. 2;

FIGS. 4 and 5 are two other perspective views of the second key shown in FIG. 2;

FIG. 6 is a cross-sectional view of the dual-key lock shown in FIG. 1;

FIG. 7 is a cross-sectional view of the dual-key lock in another position than shown in FIG. 6;

FIG. 8 is another cross-sectional view of the dual-key lock shown in FIG. 6;

FIGS. 8A to 8E are cross-sectional views of locking plates and a restraining plate of the dual-key lock shown in FIG. 8;

FIG. 9 is a cross-sectional view of the second key inserted in a spindle of the dual-key lock shown in FIG. 6;

FIGS. 9A to 9E are cross-sectional views of the locking plates and the restraining plate of the dual-key lock shown in FIG. 9;

FIG. 10 is a cross-sectional view of the first key inserted in the spindle of the dual-key lock shown in FIG. 7;

FIGS. 10A to 10E are cross-sectional views of the locking plates and the restraining plate of the dual-key lock shown in FIG. 10;

FIG. 11 is a cross-sectional view of the spindle moved into an indicating position as the first key is pulled out;

FIGS. 11A to 11E are cross-sectional views of the locking plates and the restraining plate of the dual-key lock shown in FIG. 11;

FIG. 12 is a cross-sectional view of the spindle in the indicating position;

FIGS. 12A to 12E are cross-sectional views of the locking plates and the restraining plate of the dual-key lock shown in FIG. 12;

FIG. 13 is a cross-sectional view of the second key inserted in the spindle in the indicating position; and

FIGS. 13A to 13E are cross-sectional views of the locking plates and the restraining plate of the dual-key lock shown in FIG. 13;

FIG. 14 is a cross-sectional view of an unlocking position of the dual-key lock in FIG. 1 by inserting one of the keys in the spindle as the spindle is in the indicating position; and

FIG. 15 is a cross-sectional view of a locking position of the dual-key lock in FIG. 1 by inserting one of the keys in the spindle as the spindle is in the indicating position.

### DETAILED DESCRIPTION OF PREFERRED EMBODIMENT

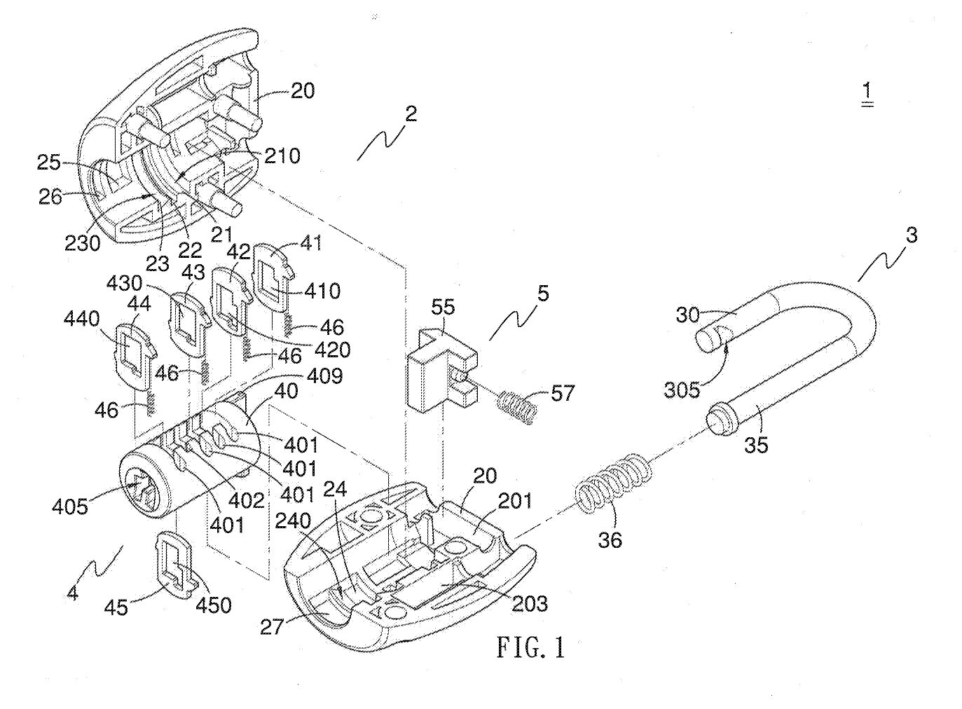

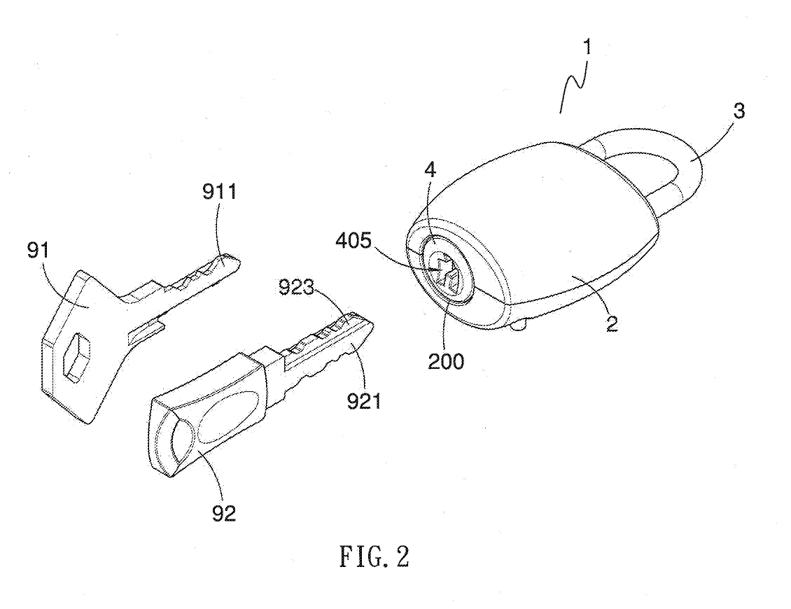

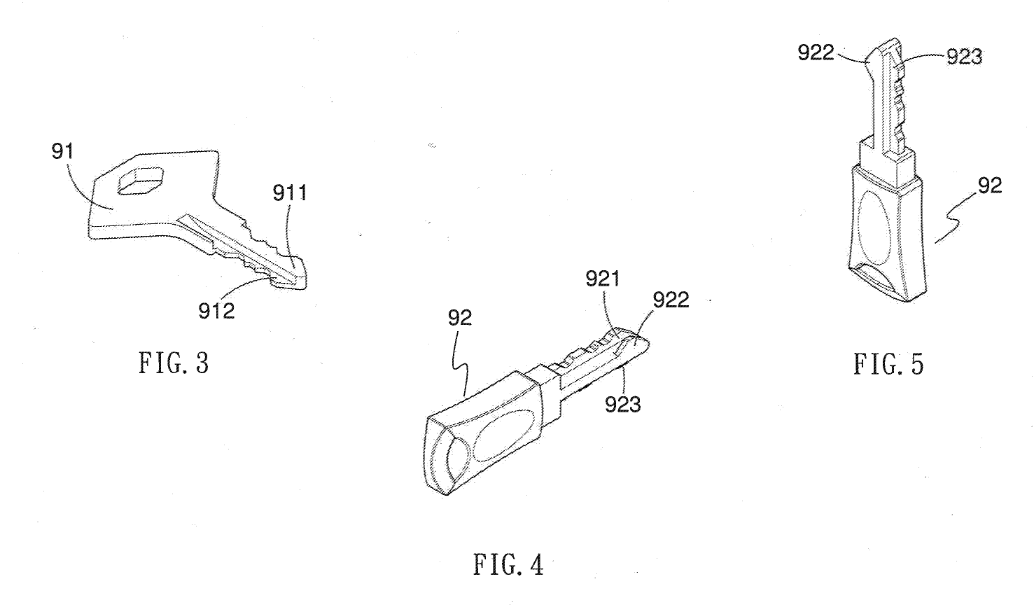

Referring to FIGS. 1 and 2, there is a dual-key lock 1 according to the preferred embodiment of the present invention. The dual-key lock 1 includes a shell 2, a latch hook 3 placed on the shell 2, a dual-key locking module 4 operable by two keys 91 and 92, and a restraining unit 5 placed in a space 201 made in the shell 2 for restraining the latch hook 3. Referring to FIGS. 2 and 3, the first key 91 includes two identical blades 911 and 912 placed on two opposite sides and biased in a direction parallel to the opposite sides. Referring to FIGS. 2, 4 and 5, the second key 92 includes three blades 921, 922 and 923. The blades 921 and 922 are separately placed on a side of the second key 92 while the blade 923 extends along a middle line of another side of the second key 92.

Referring to FIG. 1, the shell 2 includes two pieces 20 joined together and an aperture 200 made in a side. The latch hook 3 is formed with a tip 30 and a root 35. Referring to FIG. 3, the root 35 and a spring 36 are placed in a cavity 203 made in the shell 2. The spring 36 is compressed between the root 35 and a closed end of the cavity 203. The root 35 is movable along the cavity 203 by the spring 36. The tip 30 can be inserted in a cavity 202 made in an opposite side of the shell 2. The cavity 202 is in communication with the space 201. The tip 30 includes a notch 305 made in a side.

Referring to FIGS. 1 and 2, the dual-key locking module 4 is placed in the shell 2. Access to the dual-key locking module 4 is through the aperture 200 of the shell 2. The dual-key module 4 includes a spindle 40, four locking plates 41, 42, 43 and 44, a restraining plate 45 and four springs 46. Each of the springs 46 and a corresponding one of the locking plates 41 to 44 are placed in a corresponding pocket 401 made in the spindle 40. The restraining plate 45 is placed in a pocket 402 made in the spindle 40. The spindle 40 further includes a passageway 405 in communication with the pockets 401 and 402. The keys 91 and 92 can be inserted in the passageway 405 through apertures 410, 420, 430, 440 and 450 made in the locking plates 41 to 44 and the restraining plate 45, respectively.

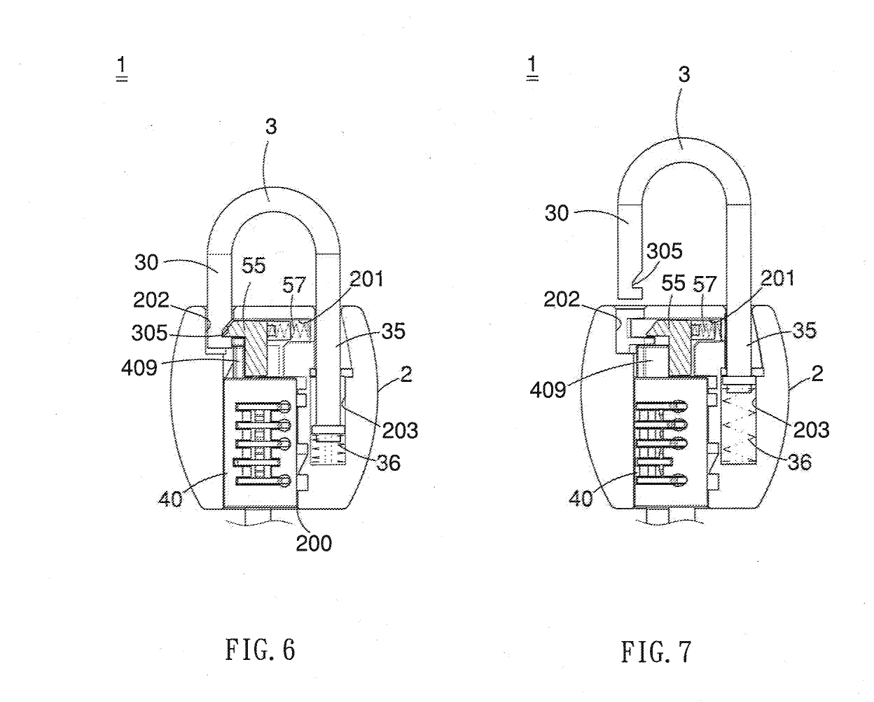

Referring to FIGS. 1 and 6, the restraining unit 5 includes a tongue 55 and a spring 57 compressed between the tongue 55 and a closed end of the space 201 of the shell 2. The spring 57 biases the tongue 55 into the cavity 202 of the shell 2 and further into the notch 305 of the tip 30 of the latch hook 3 to prevent the latch hook 3 from movement relative to the shell 2. Thus, the latch hook 3 stays in a closed position. The root 35 is biased by the spring 36, which is loaded. The tongue 55 is connected to a tab 409 extending from the spindle 40. When the key 91 or 92 is used to rotate the spindle 40, the tab 409 abuts the tongue 55 to move the tongue 55 out of the notch 305 of the tip 30 to release the latch hook 3 as shown in FIG. 7. Now, the spring 36 moves the latch hook 3 upward to allow the tip 30 to freely rotate about the root 35 from the closed position.

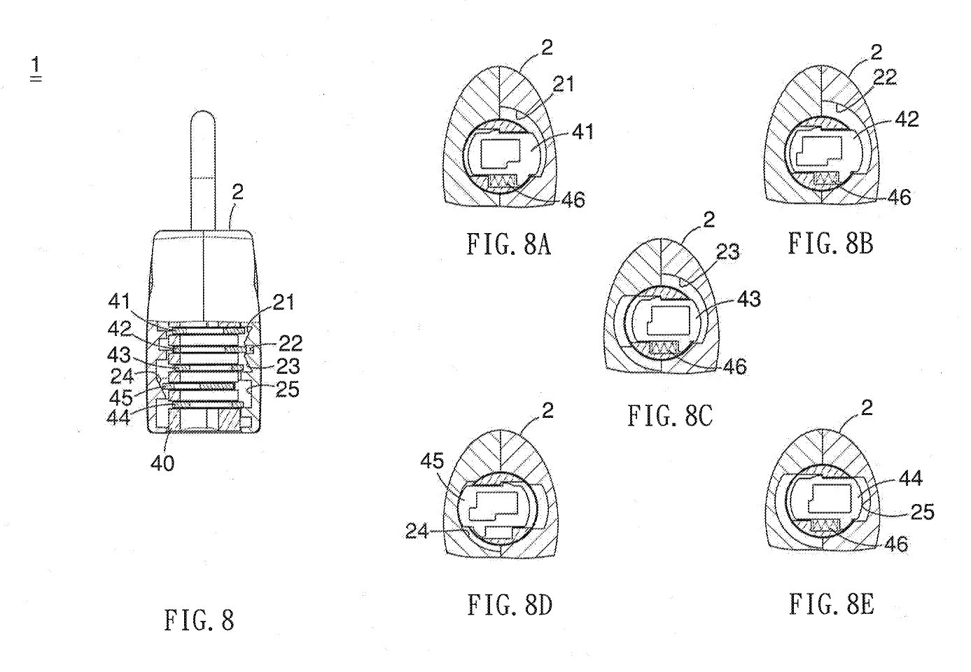

Referring to FIGS. 1 and 8, the spindle 40 is in an original position in the shell 2 before the first key 91 or the second key 92 is inserted therein. The locking plate 41 is biased by the corresponding spring 46 and partially inserted in a recess 21 made in an internal side of the shell 2 as shown in FIGS. 8 and 8A. The locking plate 42 is biased by the corresponding spring 46 and partially inserted in a recess 22 made in the internal side of the shell 2 as shown in FIGS. 8 and 8B. The locking plate 43 is biased by the corresponding spring 46 and partially inserted in a recess 23 made in the internal side of the shell 2 as shown in FIGS. 8 and 80. The restraining plate 45 is partially inserted in a recess 24 made in the internal side of the shell 2 as shown in FIGS. 8 and 8D. The locking plate 44 is biased by the corresponding spring 46 and partially inserted in a recess 25 made in the internal side of the shell 2 as shown in FIGS. 8 and 8E. Now, the locking plate 44 is restrained by the wall of the recess 25 of the shell 2 so that spindle 40 cannot be rotated relative to the shell 2.

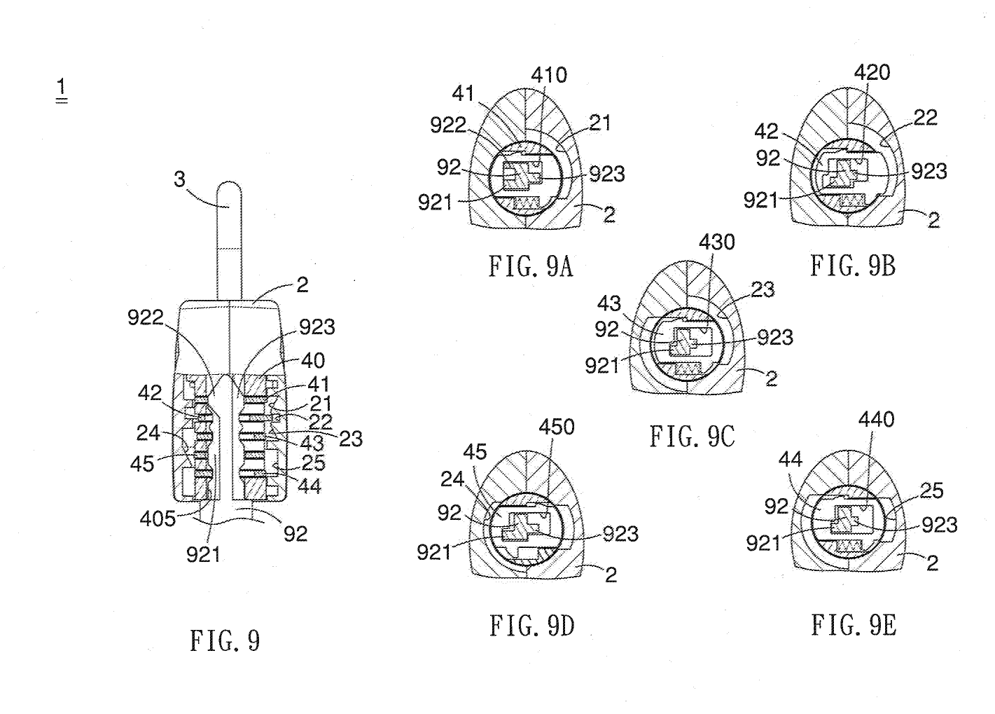

Referring to FIG. 9, as the second key 92 is inserted in the passageway 405 of the spindle 40, the walls of the apertures 410, 430, 440, 450 of the locking plates 41, 43 and 44 and the restraining plate 45 are abutted by the second key 92 so that the locking plates 41, 43 and 44 and the restraining plate 45 are not trapped in the shell 2 as shown in FIGS. 9, 9A, 9C, 9D and 9E. Now, the locking plate 42 is still placed in the recess 22 of the shell 2 although it is not pushed by the second key 92 as shown in FIGS. 9 and 9B. The locking plate 42 is movable in the recess 22 so that the second key 92 can move the spindle 40 relative to the shell 2 to move the tongue 55 out of the notch 305 of the tip 30 as shown in FIG. 7. Then, the dual-key lock can be moved into a locking position by turning the second key 92 in an opposite direction. Moreover, the locking plate 42 is still trapped in the recess 22 of the shell 2 to prevent the second key 92 from rotating the spindle 40 any further to avoid movement of the spindle 40 out of the shell 2.

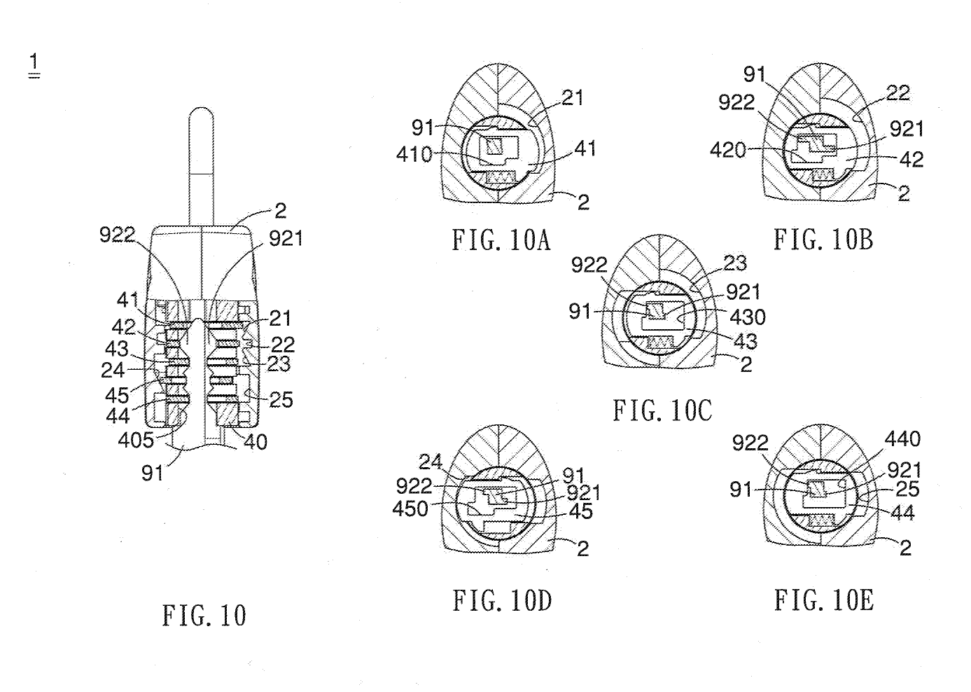

Referring to FIG. 10, when the first key 91 is inserted in the passageway 405 of the spindle 40, the first key 91 abuts the walls of the apertures 420, 430 and 440 of the locking plates 42, 43 and 44 so that the locking plates 42, 43 and 44 are not trapped in the shell 2 as shown in FIGS. 10, 10B, 100 and 10E. On the contrary, the locking plate 41 and the restraining plate 45 are not abutted by the first key 91 and are still placed in the recesses 21 and 24 as shown in FIGS. 10, 10A and 10D. However, the first key 91 can still move the spindle 40 relative to the shell 2 to turn the dual-key lock 1 into an unlocking position since the locking plate 41 and the restraining plate 45 are movable in the recesses 21 and 24. Then, the dual-key lock 1 can be moved into the locking position by turning the first key 91 in an opposite direction.

As described above, the spindle 40 can be turned by any one of keys 91 and 92 that is inserted therein as the spindle 40 is in the original position. Thus, the spindle 40 can be turned between the locking position and the unlocking position.

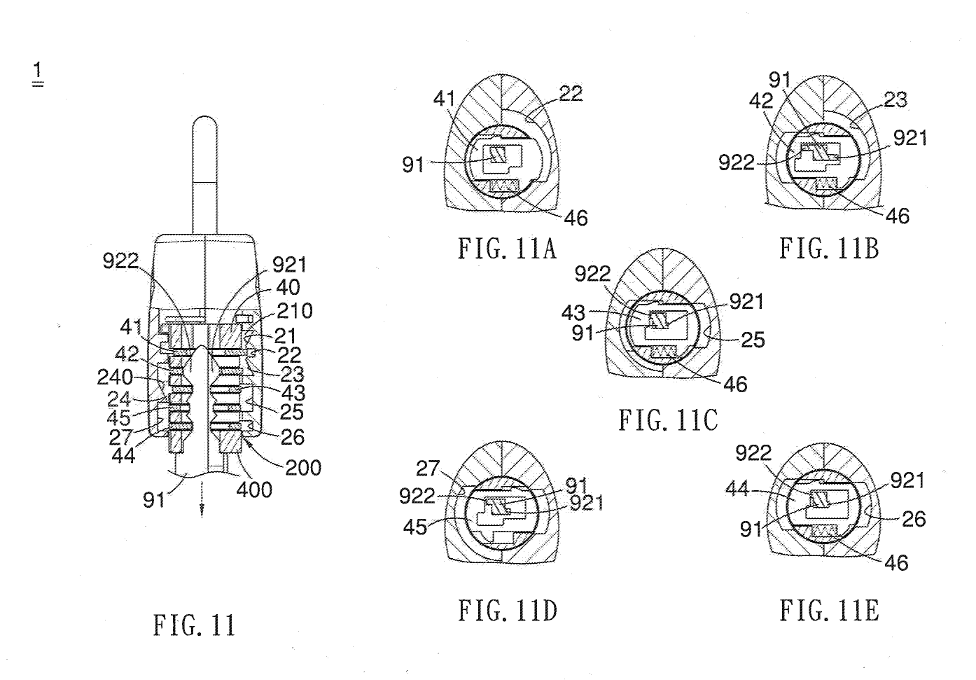

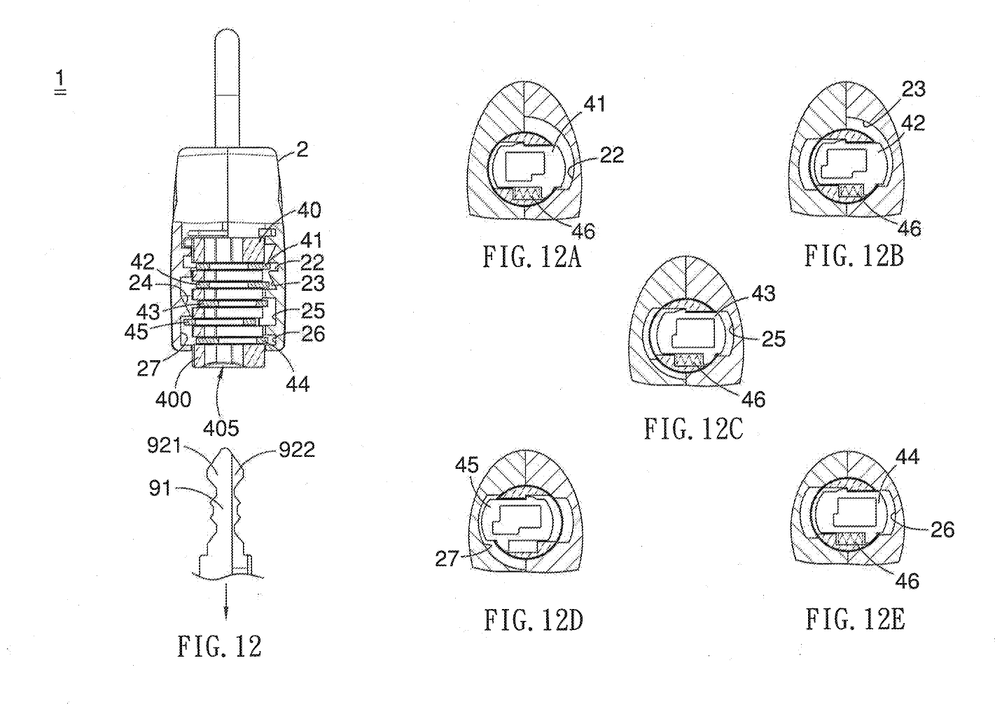

Referring to FIG. 11, the first key 91 is to be pulled out of the spindle 40. The key 91 pulls the locking plates 43 and 44 and the restraining plate 45 to rectilinearly move the spindle 40 into an indicating position outside the cavity 203 from the original position. Now, an end 400 of the spindle 40 is outside the shell 2. The locking plate 41 and the restraining plate 45 of the spindle 40 are still trapped in the recesses 21 and 24 of the shell 2 after the first key 91 is inserted in the passageway 405 of the spindle 40 as shown in FIGS. 10, 10A and 10D. However, the recess 21 includes a slope 210 to allow the first key 91 to move the locking plate 41 toward the exterior of the cavity 203 of the shell 2 along the slope 210 of the recess 21 and to allow the corresponding spring 46 to push the locking plate 41 into the recess 22 when the first key 91 pulls the spindle 40 outward referring to FIGS. 11, 11A and 12A. The recess 24 includes a slope 240 to allow the first key 91 to move the restraining plate 45 outward along the slope 240 of the recess 24 of the shell 2.

Referring to FIG. 12, the locking plates 42, 43 and 44 (FIGS. 10 and 11), which were abutted by the first key 91, are pushed into the recesses 23 and 25 and a recess 26 made in the shell 2 by the corresponding springs 46 as the first key 91 is pulled out of the spindle 40 as shown in FIGS. 12B, 12C and 12E. Moreover, the first key 91 pushes the restraining plate 45 into a recess 27 made in the shell 2 as the first key 91 is pulled out of the spindle 40 as shown in FIG. 12D. The spindle 40 cannot be moved back into the cavity 203 of the shell 2 completely since the locking plates 41, 42, 44 and the restraining plate 45 are trapped in the shell 2. Moreover, the spindle 40 cannot be moved further out of the shell 2 since the locking plates 41, 42 and 44 are trapped in the shell 2. Thus, the spindle 40 stays in the indicating position after the first key 91 is inserted in and removed out of it.

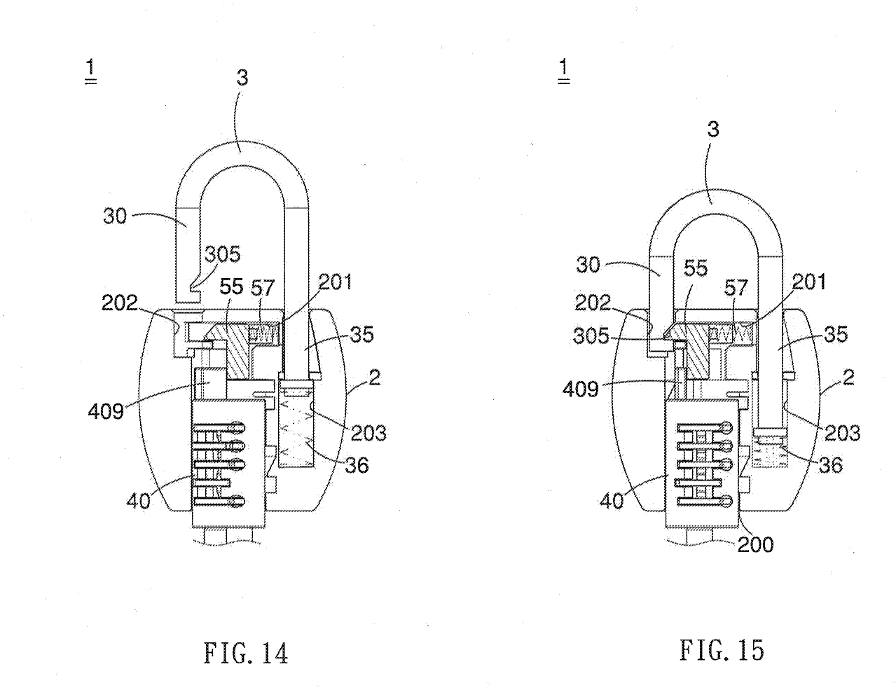

After the spindle 40 is moved into the indicating position by the first key 91, the spindle 40 can again be moved between the locking position and the unlocking position by the first key 91. That is, the first key 91 can again be inserted in the passageway 405 of the spindle 40 and turned to abut the walls of the apertures 420, 430 and 440 of the locking plates 42, 43 and 44 to move the locking plates 42, 43 and 44 out of the shell 2 to allow the first key 91 to rotate the spindle 40 between the unlocking position (FIG. 14) and the locking position (FIG. 15). Similarly, when the spindle 40 is in the indicating position, the spindle 40 can be moved between the unlocking position and the locking position by the second key 92 in a process similar to the process described referring to FIG. 9. In brief, as the spindle 40 is in the indicating position, the spindle 40 can be moved between the unlocking position and the locking position by any one of the first key 91 or the second key 92 inserted therein.

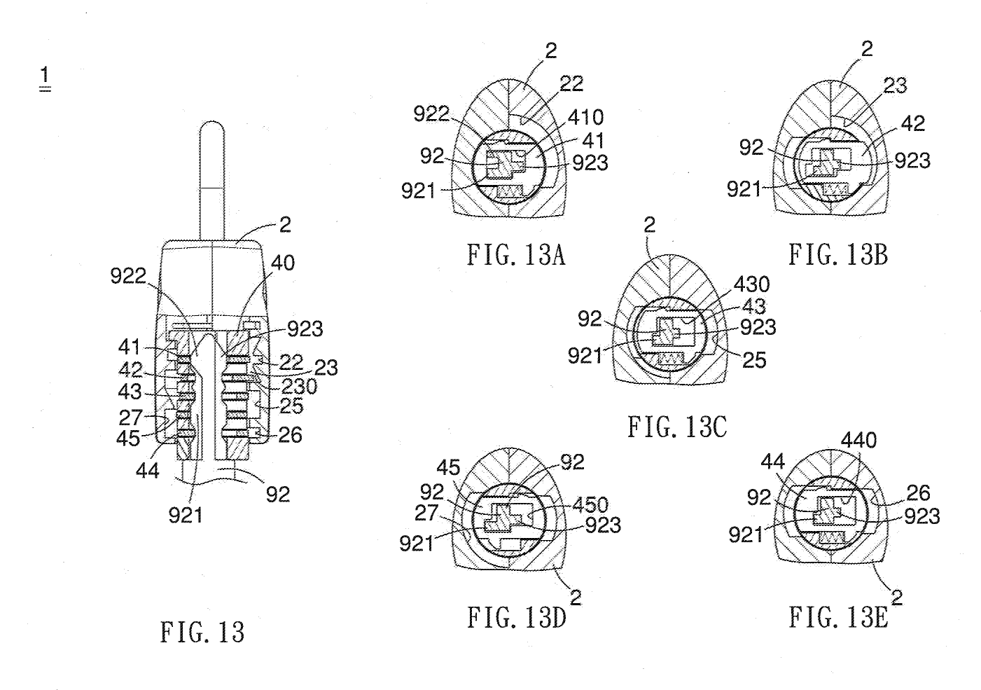

Referring to FIG. 13, the second key 92 is used to return the spindle 40 back into the original position in the shell 2 from the indicating position. In detail, the second key 92 abuts the walls of the apertures 410, 430, 440 and 450 to move the locking plates 41, 43, 44 and 45 out of the recesses 22, 25, 26 and 27 of the shell 2 as shown in FIGS. 13, 13A, 13C, 13D and 13E. Thus, the locking plates 41, 43 and 44 and the restraining plate 45 are not trapped in the shell 2. The locking plate 42 is still placed in the recess 23 of the shell 2 as shown in FIGS. 13 and 13B. However, the recess 23 includes a slope 230

(FIGS. 1 and 13) to allow the second key 92 to move the lock locking 42 inward along the slope 230 and finally out of the recess 230. The locking plate 42 is pushed into the recess 22 of the shell 2 again by the corresponding spring 46 as shown in FIG. 9. The second key 92 is pulled out of the spindle 40 before the locking plates 41, 43 and 44 are pushed into the recesses 21, 23 and 25 by the corresponding springs 46 to trap the spindle 40 in the shell 2 as shown in FIGS. 8, 8A, 8C and 8E.

In comparison with the prior art, the dual-key lock 1 includes the dual-key locking module 4 operable by the keys 91 and 92. The spindle 40 can be turned into the indicating position from the original position by the first key 91 before the two-key locking module 4 stays in the indicating position. The spindle 40 can be returned into the original position from the indicating position by the second key 92.

As clearly shown in FIG. 11, the blades 911 and 922 of the first key 91 cannot reach the first locking plate 41. In this situation, the spindle 40 cannot be returned into the original position even if it is pushed inwardly because the first locking plate 41 is still trapped in the 22. That is, the first key 91 can only be used to move the spindle 40 into the indicating position from the original position, not vice versa.

As clearly shown in FIG. 13, the blades 921 and 922 of the second key 92 can reach and move the first locking plate 41 out of the recess 22. In this situation, the spindle 40 can be pushed inwardly into the original position because the first locking plate 41 is out of the recess 22. Moreover, as clearly shown in FIG. 9, the blades 921, 922 and 923 of the second key 92 cannot contact the second locking plate 42 during the process of pulling the second key 92 out of the spindle 40. Thus, the second locking plate 42 is still trapped in the recess 22. In this situation, the spindle 40 cannot be moved. Hence, the spindle 40 cannot be moved into the indicating position while the second key 92 is pulled out of the spindle 40. That is, the second key 92 can only be used to return the spindle 40 into the original position from the original position, not vice versa.

As discussed above, any one of the keys 91 and 92 can be inserted in the spindle 40 and used to turn the dual-key lock 1 between the unlocking position and locking position. However, the first key 91 can only be used to turn the spindle 40 into the indicating position from the original position, not vice versa. The second key 92 can only be used to return the spindle 40 into the original position from the indicating position, not vice versa. Thus, the spindle 40 is in the indicating position to indicate that the dual-key lock 1 has been operated with the first key. In a case, the first key 91 is held by an inspector from the customs while the second key 92 is held by an owner of the dual-key lock 1. Hence, observing the spindle 40 in the indicating position, the owner knows that the first key 91 has been used to operate the dual-key lock 1. Moreover, only the second key 92 can be used to return the spindle 40 into the original position from the indicating position. Hence, the inspector from the customs cannot use the first key 91 to return the spindle 40 into the original position. Only the owner can use the second key 92 to return the spindle 40 into the original position.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A dual-key lock movable between an unlocking position and a locking position by any one of a first key and a second key, wherein the dual-key lock includes:
a shell 2 including a recess 22; and
a dual-key locking module 4 being placed in the shell 2 and including a spindle 40 and a first locking plate 41 movable in the spindle 40, wherein the spindle 40 includes a passageway 405 for receiving any one of the first and second keys 91,92, wherein the spindle 40 is rectilinearly movable between an original position and an indicating position, wherein the first locking plate 41 extends into the recess 22 from the spindle 40 to prevent the spindle 40 from movement back into the original position as the spindle 40 is in the indicating position.

2. The dual-key lock according to claim 1, wherein the shell 2 includes an aperture 200 through which the spindle 40 is visible as the spindle 40 is in the indicating position.

3. The dual-key lock according to claim 1, wherein the first locking plate 41 is in a position not reachable by the first key 91.

4. The dual-key lock according to claim 1, wherein the first locking plate 41 is in a position reachable by the second key 92, wherein the first locking plate 41 is movable out of the recess 22 by the second key 92 to allow movement of the spindle 40 back into the original position from the indicating position as the second key 92 is inserted in the spindle 40 in the indicating position.

5. The dual-key lock according to claim 1, wherein the first locking plate 41 is in a position not reachable by the first key 91 but reachable by the second key 92, wherein the first locking plate 41 is movable out of the recess 22 by the second key 92 to allow movement of the spindle 40 back into the original position from the indicating position as the second key 92 is inserted in the spindle 40 in the indicating position.

6. The dual-key lock according to claim 1, wherein the spindle 40 is movable between the unlocking position and the locking position by any one of the first and second keys 91, 92 no matter whether the spindle 40 is in the original position or the indicating position.

7. A dual-key lock movable between an unlocking position and a locking position by any one of a first key 91 and a second key 92, wherein the dual-key lock includes a shell 2 and a spindle 40 placed in the shell 2, wherein the spindle 40 includes a passageway 405 for receiving any one of the first and second keys 91/92, wherein the spindle 40 is only movable into the indicating position from the original position by the first key 91, wherein the spindle 40 is movable between the unlocking position and the locking position by any one of the first and second keys 91/92 no matter whether the spindle 40 is in the original position or the indicating position.

8. The dual-key lock according to claim 7, wherein the spindle 40 is only movable back into the original position from the indicating position by the second key 92.

9. The dual-key lock according to claim 7, wherein the spindle 40 includes an end extending out of the shell 2 as the spindle 40 is in the indicating position.

10. The dual-key lock according to claim 7, including a restraining unit 5 placed in the shell 2 and connected to the spindle 40, wherein the restraining unit 5 is moved into a releasing position by the spindle 40 as the spindle 40 is moved into the unlocking position by any one of the first and second keys 91/92, wherein the restraining unit 5 is moved into a restraining position by the spindle 40 as the spindle 40 is moved into the locking position by any one of the first and second keys 91/92.

11. The dual-key lock according to claim 10, including a latch hook 3 connected to the shell 2 and movable between a closed position and an open position, wherein the latch hook 3 includes an end restrained by the restraining unit 5 as the latch hook 3 is in the closed position and the restraining unit 5 is in the restraining position, wherein the end of the latch hook 3 is released from the restraining unit 5 and allowed to move into the open position from the closed position as the restraining unit 5 is in the restraining position.
